(19) United States
(12) Patent Application Publication
(10) Pub. No.: US 2025/0377839 A1
(43) Pub. Date: Dec. 11, 2025

(54) SERVICE MANUAL DISPLAY METHOD, SERVICE MANUAL UPDATE METHOD, INFORMATION PROCESSING APPARATUS, MAINTENANCE, AND SUPPORT SYSTEM

(71) Applicant: CANON KABUSHIKI KAISHA, Tokyo (JP)

(72) Inventor: MICHINORI SHIODA, Kanagawa (JP)

(21) Appl. No.: 19/226,308

(22) Filed: Jun. 3, 2025

(30) Foreign Application Priority Data
Jun. 10, 2024 (JP) 2024-093860

(51) Int. Cl. G06F 3/12; G06F 3/0482

(52) U.S. Cl. CPC G06F 3/1217; G06F 3/121; G06F 3/1282; G06F 3/0482

(57) ABSTRACT

A service manual display method to be executed by a computer is provided. The method includes displaying a list of errors and/or maintenance items for an apparatus that is to be addressed; and displaying a service manual corresponding to an item selected from the listed errors and/or maintenance items. In the displaying of the service manual, work time for each selectable resolution content is displayed for a selected error or maintenance item.

### BACKGROUND

### Field of the Technology

The present disclosure relates to a service manual display method, a service manual update method, an information processing apparatus, a maintenance support system, and a medium.

### Description of the Related Art

In the field of commercial printing, a high rate of operation is required because downtime of an image forming apparatus directly leads to reduced profits. When an error occurs in an image forming apparatus or when maintenance is required, a skilled operator on the customer's side first handles the situation. However, if the operator is unable to handle the situation, a maintenance worker from the manufacturer or vendor is dispatched to the location where the image forming apparatus is installed to handle the situation. Both operators and maintenance workers are required to complete their work in a short amount of time to minimize downtime.

To make this work more efficient, there are maintenance support systems that support maintenance work by displaying errors and maintenance items that operators and maintenance workers (hereinafter collectively referred to as workers) need to address as a work list, in order of priority level. The worker refers to this work list and performs the work in order of priority level. When performing this work, a service manual describing a work procedure for an item selected from the work list can be checked, making the work more efficient.

In a maintenance support system that uses such a work list to show a resolution method, there are cases where it is not possible to limit the resolution methods to one resolution method. There may not be just one possible cause for an error, and therefore a plurality of resolution methods are presented in some cases. In this case, it is up to the worker to select the resolution from the plurality of resolution methods. A worker lacking experience may have difficulty making the right selection. For this reason, Japanese Patent Laid-Open No. 2020-199704 proposes communicating with a failure diagnosis server at a dispatch destination and receiving support from the failure diagnosis server. The failure diagnosis server estimates the cause of the failure from various types of device information, such as errors received from the image forming apparatus, narrows down a plurality of possible causes, and presents the result to the worker.

However, even if the cause of the failure is presented, if work time is limited, it may not be possible to complete the work within that time. For example, a worker may not be able to visit a client and begin the work until nighttime. This may be the case, for example, if maintenance is performed after the customer's business hours, or if an error occurs at night. In this case, the time that the worker can spend on repair and maintenance is significantly more limited than in the morning or afternoon. For this reason, even when repair or maintenance is in progress, the worker may be sent home by the customer, and the worker must adjust his or her schedule and visit the customer again. This not only increases the workload, but also increases the downtime of the equipment to be repaired, resulting in loss of profits for the customer.

### SUMMARY

The present disclosure allows an operator to select a feasible resolution method for a failure or the like, with consideration given to the work time.

According to one aspect of the present disclosure, there is provided a service manual display method to be executed by a computer, comprising: displaying a list of errors and/or maintenance items for an apparatus that is to be addressed; and displaying a service manual corresponding to an item selected from the listed errors and/or maintenance items, wherein in the displaying of the service manual, work time for each selectable resolution content is displayed for a selected error or maintenance item.

According to another aspect of the present disclosure, there is provided a maintenance support system comprising a first information processing apparatus and a second information processing apparatus, wherein the first information processing apparatus includes: at least one memory storing instructions; and at least one processor that is in communication with the at least one memory and that, when executing the instructions, cooperates with the at least one memory to execute processing, the processing including: displaying a list of errors and/or maintenance items for an apparatus that is a target of resolution; and displaying a service manual corresponding to an item selected from the listed errors and/or maintenance items, in the displaying of the service manual, work time for each selectable resolution content for the selected error or maintenance item is displayed, the second information processing apparatus includes: at least one memory storing instructions; and at least one processor that is in communication with the at least one memory and that, when executing the instructions, cooperates with the at least one memory to execute processing, the processing including: creating statistical information associating respective work times with resolution methods that can be selected for the errors or maintenance items of the target apparatus based on information indicating a record of maintenance work; and updating the service manual by associating the statistical information with a resolution method for the error or maintenance item in the service manual, the processing of the first information processing apparatus further includes downloading an updated service manual by the second information processing apparatus, and in the displaying of the service manual, the downloaded service manual is displayed.

According to the above configuration, a worker can select a feasible resolution method for a failure or the like, with consideration given to the work time.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an entire maintenance support system according to a first embodiment.

FIG. 2 is a block diagram of an information processing apparatus and a maintenance service terminal according to the first embodiment.

FIG. 3 is a block diagram of a printing company system and the maintenance service terminal according to the first embodiment.

FIG. 4 is a block diagram of a service manual management system and a service work record management system according to the first embodiment.

FIG. 5 is a diagram showing an example of a screen of a work time information input unit in the first embodiment.

FIG. 6 is a diagram showing an example of a database of a service work record DB in the first embodiment.

FIG. 7 is a diagram showing an example of statistical information generated by a statistical information generation unit in the first embodiment.

FIG. 8 is a flowchart of the statistical information generation unit in the first embodiment.

FIG. 9 is a flowchart of a manual update in the first embodiment.

FIG. 10 is a diagram showing an example of a work list screen of a service tool in the first embodiment.

FIG. 11 is a diagram showing an example of a service manual screen in the first embodiment.

FIG. 12 is a diagram showing an example of a service manual screen in a third embodiment.

FIG. 13 is a diagram showing an example of a screen of a work time information input unit in a fourth embodiment.

FIG. 14 is a flowchart for changing display content in the fourth embodiment.

FIG. 15 is a flowchart of display processing performed by a maintenance service terminal.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

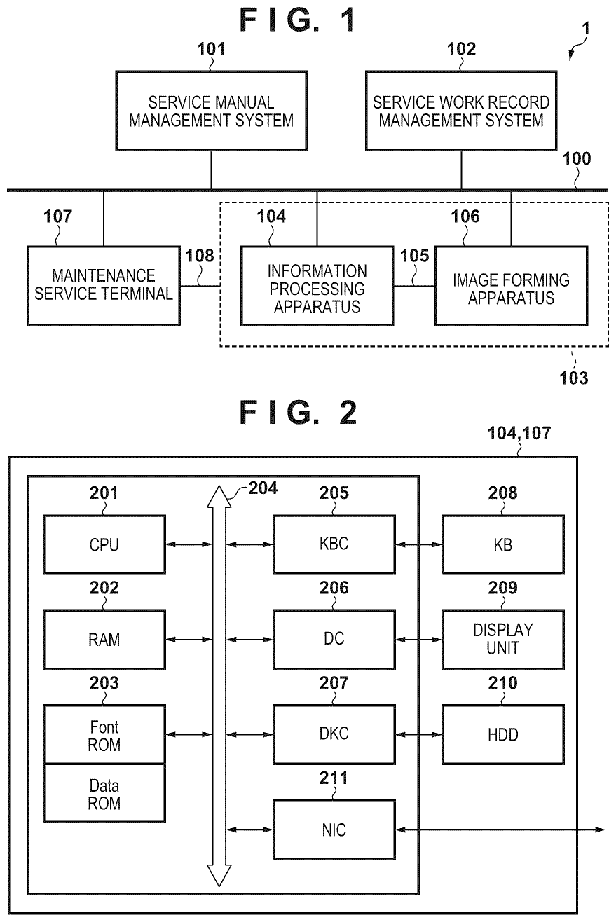

FIG. 1 is a block diagram showing the entirety of a maintenance support system according to this embodiment. This maintenance support system imports past repair history as statistical information, and based on that statistical information, ranks a plurality of presented resolution methods. The ranking information and statistical information are then embedded in advance in a service manual and downloaded to a maintenance service terminal used by a worker. The worker performs work while referring to the service manual. The configuration of this embodiment will be described below.

### Configuration of Maintenance Support System

A maintenance support system 1 is broadly divided into a service manual management system 101, a service work record management system 102, a printing company system 103, and a maintenance service terminal 107, which are all connected to each other via the Internet 100. The printing company system 103 and the maintenance service terminal 107 are connected by a local connection 108 such as a local network or a USB connection. In addition, a connection 105 between an information processing apparatus 104 and an image forming apparatus 106 may be a local connection such as a local network or USB connection, or may be a connection via the Internet.

The image forming apparatus 106 is controlled under the control of a group of programs operating on the information processing apparatus 104, processes print data in accordance with print settings, and produces a finished product. The maintenance service terminal 107 communicates with the printing company system 103 to acquire the device status and operation information of the image forming apparatus 106. The information is then used by a service tool installed in the maintenance service terminal 107 to provide a maintenance support service to a maintenance worker. When displaying a service manual for a maintenance worker, the maintenance service terminal 107 can download the service manual from the service manual management system 101 to the maintenance service terminal 107. The service work record management system 102 stores the work history of maintenance workers in a market, and is connected to the service manual management system 101 via the Internet 100.

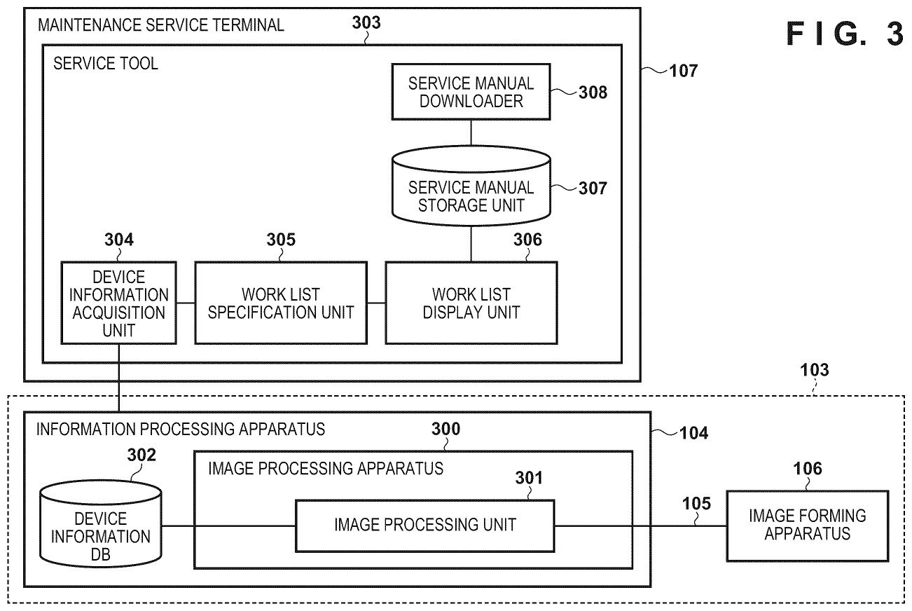

FIG. 2 is a block diagram showing a configuration of the information processing apparatus 104 and the maintenance service terminal 107. Note that as for the service manual management system 101 and the service work record management system 102 as well, one or more computers for implementing them may each have the configuration shown in FIG. 2.

In FIG. 2, a CPU 201 executes an OS and general application programs stored in a program ROM of a ROM 203 or loaded from an HDD 210 to a RAM 202. Here, the CPU is a central processing unit and is also called a processor. ROM is an abbreviation for read-only memory, RAM is an abbreviation for random access memory, HDD is an abbreviation for hard disk drive, and OS is an abbreviation for operating system. The ROM 203 includes a font ROM and a data ROM. The RAM 202 functions as a main memory, a work area, and the like for the CPU 201. A keyboard controller (KBC) 205 controls input from a keyboard (KB) 208 and a pointing device (not shown). A display controller (DC) 206 controls display on a display unit 209. A disk controller (DKC) 207 controls access to the HDD 210 or the like that stores a boot program, various applications, font data, and the like. A network controller (NIC) 211 is connected to a network and executes communication control processing with other devices connected to the network. A bus 204 connects the CPU 201, the RAM 202, the ROM 203, various controllers, and the like, and carries data signals and control signals.

FIG. 3 is a block diagram of the printing company system 103 and the maintenance service terminal 107 that constitute the maintenance support system according to this embodiment. First, functional blocks mounted in the information processing apparatus 104 of the printing company system 103 will be described.

An image processing apparatus 300 is an application for controlling the image forming apparatus 106. Communication with the image forming apparatus 106 is performed via the connection 105. When the image processing apparatus 300 receives a print execution instruction for a print job, an image processing unit 301 converts the print data into image data, and transfers the image data to the image forming apparatus 106 together with a print execution command. A device information DB 302 holds device information and operation information of the image forming apparatus 106, such as the history of print jobs performed by the image forming apparatus 106 and the history of errors that have occurred.

Next, functional blocks mounted in the maintenance service terminal 107 will be described. A service tool 303 is installed in the maintenance service terminal 107. The service tool 303 is an application that provides a maintenance worker with functions and a service manual required for maintenance and inspection of the image forming apparatus 106, and information on recommended maintenance and inspection work. The service tool 303 can display a user interface (UI) on the display unit 209 to provide information to a worker. Note that in this embodiment, the maintenance service terminal 107 has the service tool 303, but the information processing apparatus 104 may have the service tool 303, and it is possible to have a configuration in which the service tool 303 is built into the image forming apparatus 106. The service tool 303 includes a device information acquisition unit 304, a work list specification unit 305, a work list display unit 306, a service manual storage unit 307, and a service manual downloader 308.

The device information acquisition unit 304 communicates with the information processing apparatus 104 and acquires the device information and the history of operation information stored in the device information DB 302. The work list specification unit 305 specifies errors and maintenance items to be addressed based on the information acquired by the device information acquisition unit 304. The work list display unit 306 displays the errors and maintenance items to be addressed that are specified by the work list specification unit 305, on the UI of the service tool 303. The work list display unit 306 also has a function of displaying a service manual corresponding to the errors and maintenance items to be addressed. The service manual displayed on the work list display unit 306 is a service manual downloaded to the service manual storage unit 307 in the maintenance service terminal 107.

The service manual downloader 308 acquires the service manual data from the service manual management system 101 via the Internet 100, and stores the acquired service manual data in the service manual storage unit 307. The environment at the dispatch destination does not necessarily allow access to the Internet 100. For this reason, the maintenance worker connects the maintenance service terminal 107 to the Internet 100 in advance, downloads the service manual data using the service manual downloader 308, and then visits the dispatch destination.

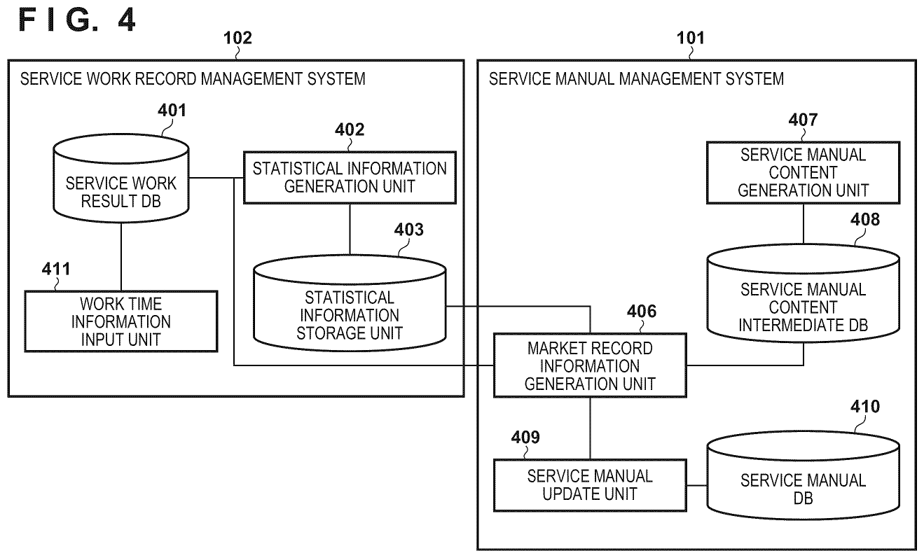

FIG. 4 is a block diagram of the service manual management system 101 and the service work record management system 102 included in the maintenance support system according to this embodiment.

First, functional blocks mounted in the service work record management system 102 will be described. The service work record management system 102 is constituted by a service work record DB 401, a statistical information generation unit 402, a statistical information storage unit 403, and a work time information input unit 411. The service work record DB 401 stores maintenance work performed by a maintenance worker and the results of the work. The registration method may be a method in which a maintenance worker performs input from the maintenance service terminal 107 or a method in which automatic registration is performed from the information processing apparatus 104 via the Internet 100. The statistical information generation unit 402 generates statistical information on work record of work carried out for each model of the image forming apparatus 106, and further for each error and maintenance inspection item that occurs in that model, from the service work record DB 401 at a fixed time (predetermined time) each day, for example, at 6:00 a.m. The statistical information on the work record may include, for example, the adoption rate of each possible resolution method for each error and maintenance inspection item. The statistical information storage unit 403 stores the statistical information generated by the statistical information generation unit 402 at least once a day, by date.

The work time information input unit 411 is an input unit for inputting information related to work time. The work time information includes the work time required for each resolution method for an error or maintenance item. In addition to this, it is also possible to input scheduled work time that a worker can spend in a day of work. The information input in the work time information input unit 411 is stored in the service work record DB 401.

Next, functional blocks mounted in the service manual management system 101 will be described. A service manual content generation unit 407 collects content data including relevant part information and resolution method information for each model of the image forming apparatus 106 and for each error and maintenance inspection item that occurs in that model, and generates intermediate data for a service manual. Here, a resolution method is also referred to as resolution content or a maintenance method in some cases. In addition to the original data of the service manual, this intermediate data of the service manual also includes a list of errors and maintenance items that may occur for each model. The generated intermediate data of the service manual is stored in a service manual content intermediate DB 408. The intermediate data is stored, for example, as data in XML format. The intermediate data of the service manual includes, for example, data indicating the work procedure for each resolution method (resolution content) in the form of text, images, and the like, as the original data of the service manual.

A market record information generation unit 406 converts the latest statistical information acquired from the statistical information storage unit 403 into, for example, an XML format such that the statistical information can be reflected in the manual, that is, embedded in the manual. Then, intermediate data of the service manual in which the statistical information is to be embedded is acquired from the service manual content intermediate DB 408, and the statistical information converted into XML format is added to the content. A service manual update unit 409 reflects the statistical information in XML format generated by the market record information generation unit 406 in a service manual DB 410 as well as the service manual content intermediate DB 408. That is, intermediate data with statistical information is generated by adding statistical information in XML format to intermediate data in XML format that includes a list of errors and maintenance items that may occur for each model. Then, the service manual content intermediate DB 408 and the service manual DB 410 are updated with the intermediate data with the statistical information, and the intermediate data with the statistical information is stored in each database.

The service manual downloader 308 in FIG. 3 acquires the service manual stored in the service manual DB 410. That is, the service manual downloader 308 downloads the content of a service manual including a list of errors and maintenance items that may occur for each model, and statistical information on work record for work performed for each error that has occurred and each maintenance inspection item for each model. The content to be downloaded may be the entire service manual, or may be only a portion related to the model of the image forming apparatus that is the target of the work. Furthermore, the content to be downloaded may be a portion related to errors and maintenance items occurring for the model of the image forming apparatus that is the target of the work. The service manual to be downloaded includes the adopted resolution methods, and the work time for each resolution method as the work record, for the errors and maintenance items for each model. Furthermore, the scheduled work time that the worker can spend in a day of work may be included.

### Registration of Work Time and Scheduled Work Time

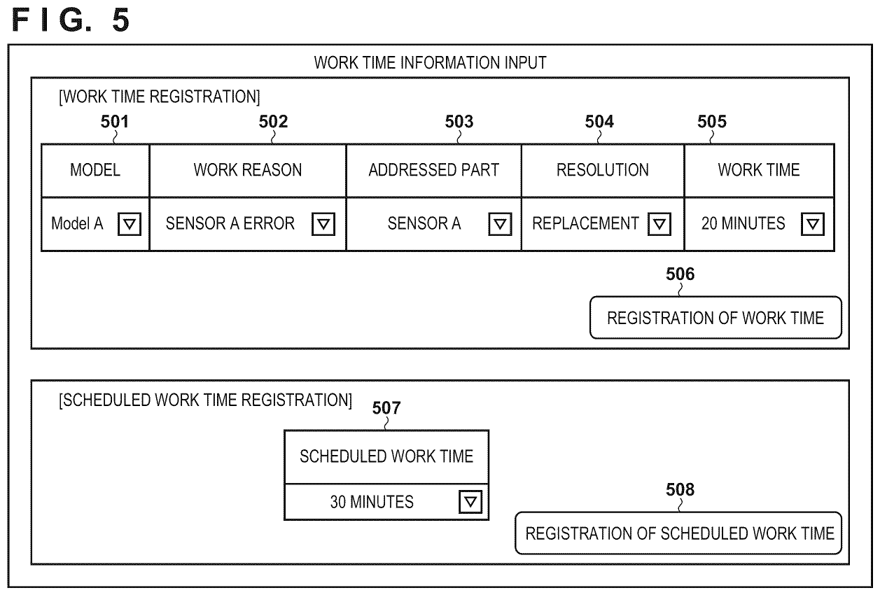

FIG. 5 is an example of a screen (UI) of the work time information input unit 411 according to this embodiment. As shown in FIG. 5, the service work record DB 401 allows “registration of work time” and “registration of scheduled work time” to be performed independently.

“Registration of work time” is a screen for registering the actual work time required for each resolution method related to an error or maintenance item. First, a model 501, a work reason 502, an addressed part 503, and a resolution 504 are selected from the pull-down menus to uniquely identify the resolution method. For example, “Model A” is selected in the model 501, “sensor A error” is selected in the work reason 502, “sensor A” is selected in the addressed part 503, and “replacement” is selected in the resolution 504. Next, the work time 505 required for this resolution method is selected from the pull-down menu. At this time, for example, the work time can be selected in predetermined time units, for example, in 5-minute units. For example, “20 minutes” is selected. After a value is entered in the work time 505, a “registration of work time” button 506 is pressed. As a result, the record value when the work is actually performed is registered in the service work record DB 401 as the work time. Additionally, the work result may be registered through the UI of the work time information input unit 411 shown in FIG. 5.

“Registration of scheduled work time” is a screen for inputting the scheduled work time that a worker can spend in a day of work. In scheduled work time 507, similar to the work time 505, scheduled work time is selected from a pull-down menu in units of a predetermined time, for example, five minutes. After inputting the scheduled work time 507, the user presses a “register scheduled work time” button 508. As a result, the scheduled work time is registered in the service work record DB 401.

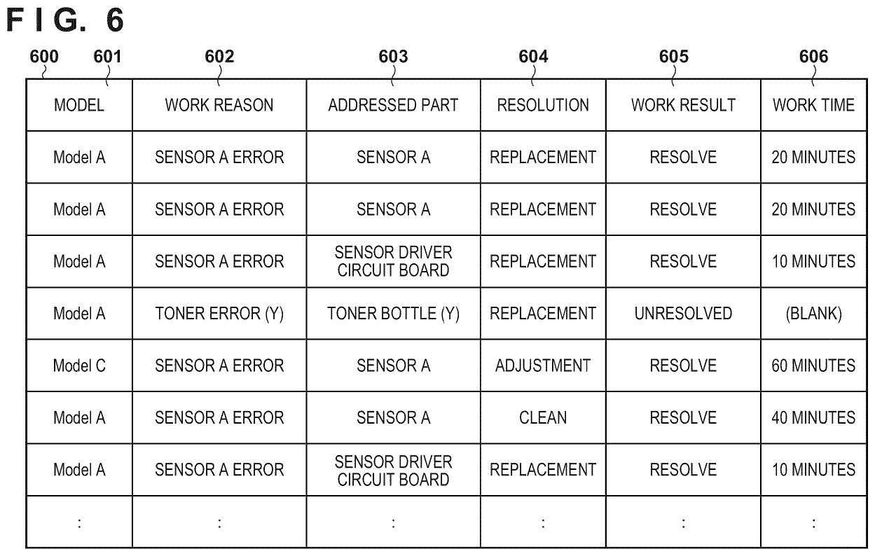

FIG. 6 shows an example of data stored in the service work record DB 401 of FIG. 4. A work record database 600 is constituted by six columns. A model column 601 stores the name of the model for which maintenance work was performed. A work reason column 602 stores the error or maintenance item that was the reason for performing the maintenance work. An addressed part column 603 stores information about the parts for which the resolution method was performed. In this embodiment, the part name is stored, but a part ID indicating the part may also be stored. A resolution column 604 stores the classification of the resolution method taken for the addressed part column 603. In this embodiment, selection is performed from three categories, namely “replacement”, “cleaning”, and “adjustment”. A work result column 605 stores the result of the maintenance work, such as whether the error was resolved after the maintenance work and whether the maintenance item was completed. A work time column 606 stores the work time required for each work. The data registered in “registration of work time” in FIG. 5 is registered here. Note that the work time column 606 stores work time only when the work result column 605 indicates “resolved”.

When the work result column 605 indicates “not resolved”, the work time column 606 for that work is fixed to a blank space.

The data registered in the “registration of scheduled work time” in FIG. 5 is registered as a table in a database separate from that in FIG. 6. The columns are “registration date” and “work time”, where “registration date” stores the date registered in “registration of scheduled work time”, and “work time” stores the data registered in “registration of scheduled work time” in FIG. 5. (Not shown)

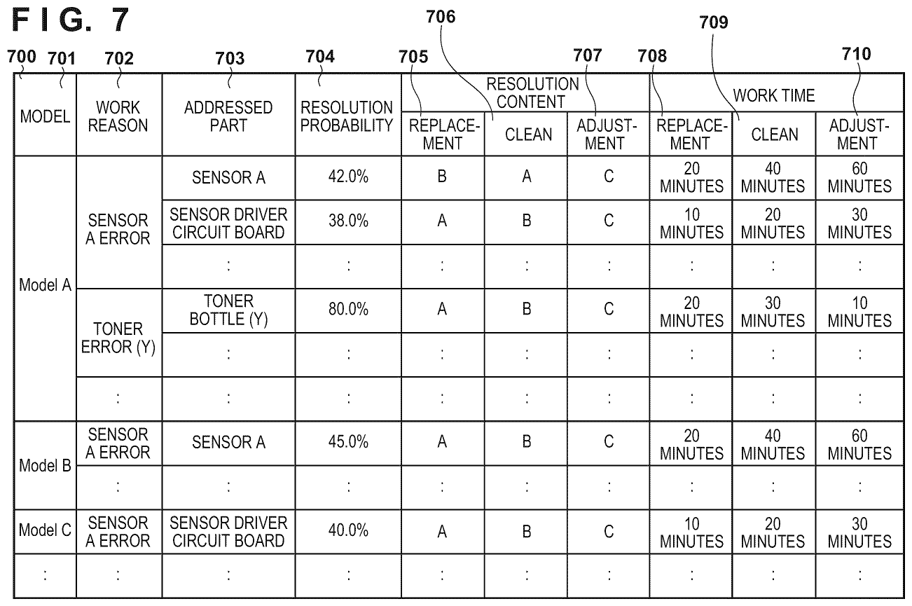

FIG. 7 shows an example of data of statistical information stored in the statistical information storage unit 403 of the service work record management system 102 of FIG. 4. The statistical information 700 is constituted by ten columns. The result of aggregation performed by the statistical information generation unit 402 for the data in the service work record DB 401 is stored. A model column 701 stores the model name of the image forming apparatus 106 on which maintenance work was performed. This corresponds to the model column 601 in the work record database 600. A work reason column 702 stores the error or maintenance item that was the reason for performing the maintenance work. This corresponds to the work reason column 602 in the work record database 600. An addressed part column 703 stores information about the part that was addressed. This corresponds to the addressed part column 603 in the work record database 600. In this embodiment, the part name is stored, but a part ID indicating the part may also be stored.

A resolution probability column 704 stores the ratio of records of resolutions performed with respect to the addressed part column 703 based on the results collected by the statistical information generation unit 402. A replacement column 705 of resolution content stores the ranks of resolution records where the resolution column 604 of the work record database 600 belongs to “replacement” from the results collected by the statistical information generation unit 402. The rank is determined according to the ratio of “replacements” with respect to the total number of target addressed parts that have been addressed, with a ratio of 50% or more being A, 20% or more but less than 50% being B, and less than 20% being C. However, the rank determination method of the present embodiment is merely an example, and there is no limitation to this, and a percentage [%] value of the ratio may be stored instead of the rank. Similarly, a cleaning column 706 and an adjustment column 707 of the resolution content store the rank of the resolution record where the resolution column 604 of the work record database 600 belongs to “cleaning” and “adjustment” from the results collected by the statistical information generation unit 402.

In a replacement column 708 of work time, the record value of the work time corresponding to the replacement column 705 of the resolution content is stored from the results collected in the statistical information generation unit 402. Similarly, a cleaning column 709 of work time stores the record data of the work time corresponding to the cleaning column 706 of the resolution content, and an adjustment column 710 of the work time stores the record data of the work time corresponding to the adjustment column 707 of the resolution content.

### Statistical Information Generation Processing

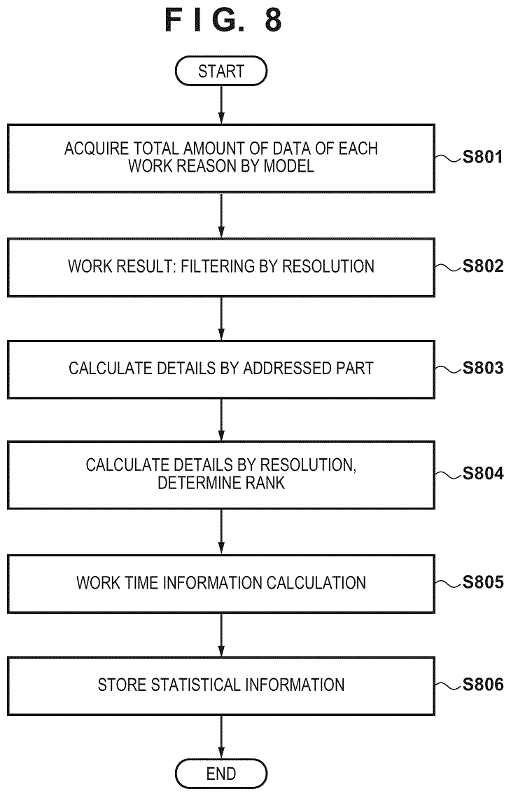

FIG. 8 is a flowchart showing a flow of processing of the statistical information generation unit 402 of FIG. 4. However, the processing method of this embodiment is merely an example and there is no limitation to this. The processing of FIG. 8 is executed by the CPU 201 of the service work record management system 102. Every day at a specified time, for example, 6:00 a.m., this flowchart is started. First, in step S801, the number of occurrences of each work reason in the work reason column 602 is calculated for each model in the model column 601 stored in the work record database 600. Next, in step S802, filtering for limiting the items (records) to those whose value in the work result column 605 is “resolved” is performed.

Next, in step S803, the number of occurrences of each of the addressed parts in the addressed part column 603 is found for each work reason for the records whose value in the work result column 605 limited in step S802 is “resolved”. Then, the ratio of addressed parts is calculated from the occurrence frequency of each addressed part obtained earlier, using the occurrence frequency of each work reason obtained in step S801 as a parameter. That is, the ratio of addressed parts for each model and each work reason is obtained. The result is stored in the resolution probability column 704 of the statistical information 700.

In step S804, the number of occurrences of each of the resolution contents “replacement”, “cleaning”, and “adjustment” in the resolution column 604 is further obtained for each addressed part. Then, the ratio of each of the resolution contents is calculated from the occurrence frequency of each of the resolution contents calculated above, using the occurrence frequency of each addressed part in step S803 as a parameter. That is, the ratio of each of the resolution contents “replacement”, “cleaning”, and “adjustment” for each model, work reason, and addressed part is obtained. The calculated ratio is then converted into a rank using the method described in FIG. 7, for example, by comparison with a threshold value, and the results are stored in the replacement column 705, the cleaning column 706, and the adjustment column 707 of the statistical information 700, respectively.

In step S805, the record values for work time are stored in the replacement column 708, the cleaning column 709, and the adjustment column 710 for each of the resolution contents “replacement”, “cleaning”, and “adjustment” of each addressed part. When there are a plurality of record values for the same model, the same work reason, and the same addressed part within the database 500, the histogram may be divided into classes of, for example, 5-minute intervals, and the work time with the highest relative frequency may be used as the record value. Alternatively, the maximum value or the average value may be used as the record value. When using the average value as the record value, it is also possible to adopt the concept of a safety factor and add a positive fraction serving as a margin of time to the average value, or the like.

In step S806, the statistical information 700 generated in steps S801 to S805 is stored in the statistical information storage unit 403. At this time, since the processing of this flowchart is executed every day, the stored results are stored in association with the date such that they can be distinguished.

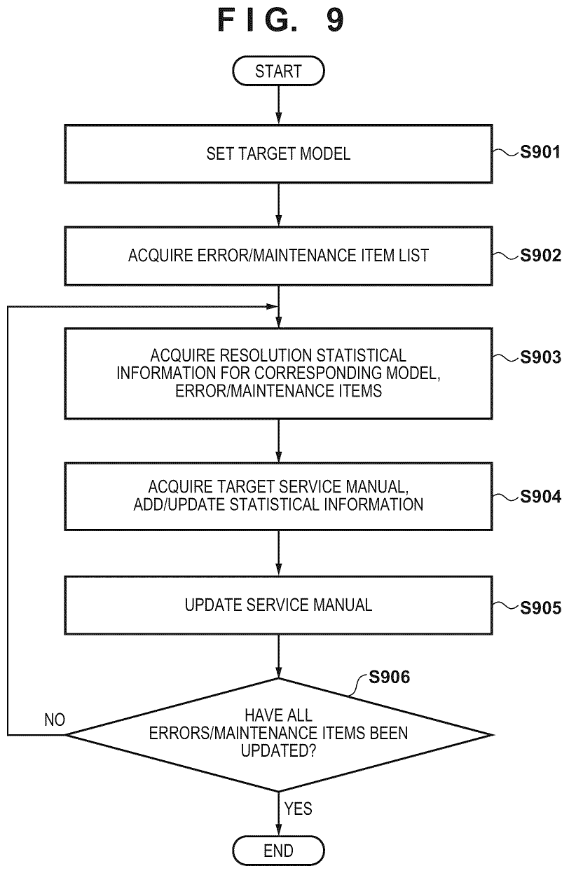

Through the above procedure, the statistical information 700 shown in FIG. 7 is generated and stored in the statistical information storage unit 403. Note that the created statistical information 700 is added to the intermediate data of the service manual in the manner shown in FIG. 9, and is stored in the service manual DB 410.

### Manual Update Processing

FIG. 9 is a flowchart showing the flow of manual updating in the service manual management system 101 of FIG. 4. The processing in FIG. 9 is executed by the CPU 201 of the service manual management system 101. First, in step S901, the market record information generation unit 406 acquires model information of the designated service manual update target from the service manual update unit 409, and sets the target model for the service manual update. Next, in step S902, the market record information generation unit 406 acquires a list of errors and maintenance items that may occur for the target model from the service manual content intermediate DB 408. Next, in step S903, the market record information generation unit 406 acquires the statistical information 700 for an error or maintenance item of the target model from the statistical information storage unit 403. Specifically, the addressed part 703, the resolution probability 704, the resolution contents 705, 706, and 707, and the work times 708, 709, and 710 are acquired for which the model name acquired in step S901 matches the model column 701 in FIG. 7 and the error or maintenance item acquired in step S902 matches the work reason column 702 in FIG. 7. At the same time, the market record information generation unit 406 acquires, from the service work record DB 401, the scheduled work time registered in the “registration of scheduled work time” in FIG. 5.

Next, in step S904, the market record information generation unit 406 acquires intermediate data of the service manual for the target model and the error or maintenance item acquired in steps S901 and S902 from the service manual content intermediate DB 408. Then, the statistical information 700 acquired in step S903 is embedded in this intermediate data. For example, if the intermediate data is in XML format, embedding may mean adding a tag describing the statistical information 700 to a tag for an error or maintenance item. Even if the statistical information is in another format, it need only be added by associating the statistical information with the corresponding item in the service manual using, for example, identification information of the error or maintenance item. At this time, the work time information is written so that it is displayed in the respective cells of the resolution contents “replacement”, “cleaning”, and “adjustment”. Note that in this embodiment, if a value other than 0 is written in the work time information, the service tool 303 may display that value, and if the value is 0, it may not be displayed. In addition, when embedding the statistical information, the parts are rearranged in descending order of the resolution probability 704 such that the maintenance worker can easily check the record order. Note that if the content acquired from the service manual DB 410 already includes statistical information, the statistical information may be overwritten and updated with new statistical information.

Through this step, for example, in addition to text or the like indicating the addressed part and the resolution content (i.e., the resolution method) corresponding to the error or maintenance item for each model (i.e., the work reason for each model), the following content is added to the corresponding work reason. First, there is the resolution probability for each addressed part, which indicates the rate at which each part is selected from among selectable addressed parts. Furthermore, there is a rank for each resolution content, which indicates a classification based on a predetermined threshold value of the rate at which each resolution method is selected from among the resolution contents selectable for each addressed part. Furthermore, the time required for each resolution content is also shown. In this embodiment, both values are obtained based on the record.

Next, in step S905, the service manual update unit 409 updates the service manual DB 410 with the service manual in which the work time information has been embedded in step S904. Finally, in step S906, the market record information generation unit 406 checks whether the statistical information embedding processing from step S903 to step S905 has been performed for all of the errors and maintenance items in the list acquired in step S902. If the statistical information embedding processing has not been completed, the processing returns to step S903, and the statistical information embedding processing is repeated for the list of unprocessed errors and maintenance items. If completed, the embedding processing ends.

By following the above procedure, the service manual can be updated and statistical information for each error and maintenance item can be embedded. Then, at least a part of the updated service manual is downloaded by the service manual downloader 308 of the maintenance service terminal 107 and stored in the service manual storage unit 307.

### User Interface

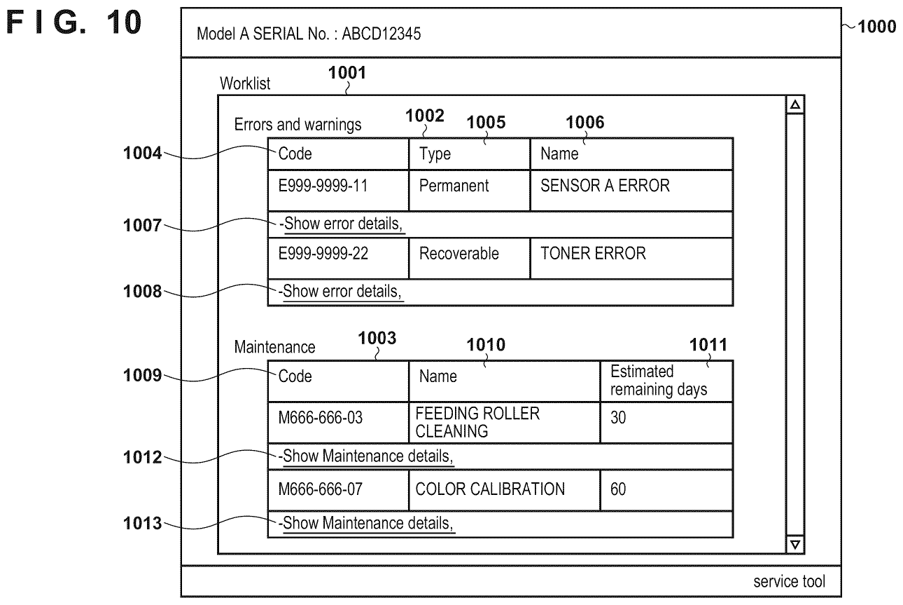

FIG. 10 is an example of a screen of the work list display unit 306 in FIG. 3. That is, the UI of FIG. 10 is displayed on the display unit of the maintenance service terminal 107. The work list is a list of relevant models and errors (and maintenance items). At the dispatch destination, the maintenance worker connects the printing company system 103 to the maintenance service terminal 107 and starts up the service tool 303. The service tool 303 has a work list display unit 306, which enables a maintenance worker to check a work list of errors and maintenance items that are to be addressed.

For example, the service tool 303 obtains model identification information of the connected device and information regarding errors and maintenance work from the device information DB 302. The service manual in the service manual storage unit 307 is then searched for using the acquired information to acquire contents relating to the corresponding model and the corresponding error and maintenance work. For example, if the information that can be acquired from the specified device is an error code, the content data corresponding to the error code is acquired. The error code, maintenance item code, and the like, as well as the type and name of the corresponding error or maintenance item, are applied to a predetermined format as a worklist and displayed as shown in FIG. 10. Note that the content information of the service manual is associated with the work list by link information embedded in the work list, as described below.

In FIG. 10, a screen 1000 is displayed on the work list display unit 306, and displays therein a work list 1001 of maintenance work to be performed by a maintenance worker. The screen 1000 displays, as its title, the model name and serial number that are to be worked on. The content is the model work list displayed in the title.

The work list 1001 is further constituted by a work list 1002 for errors and a work list 1003 for maintenance items. However, the screen configuration of this embodiment is merely an example and there is no limitation to this. For example, the work list 1002 for errors and the work list 1003 for maintenance items may be integrated and displayed as a single work list, or information related to maintenance work other than the work list 1001 may be added to the work list 1000.

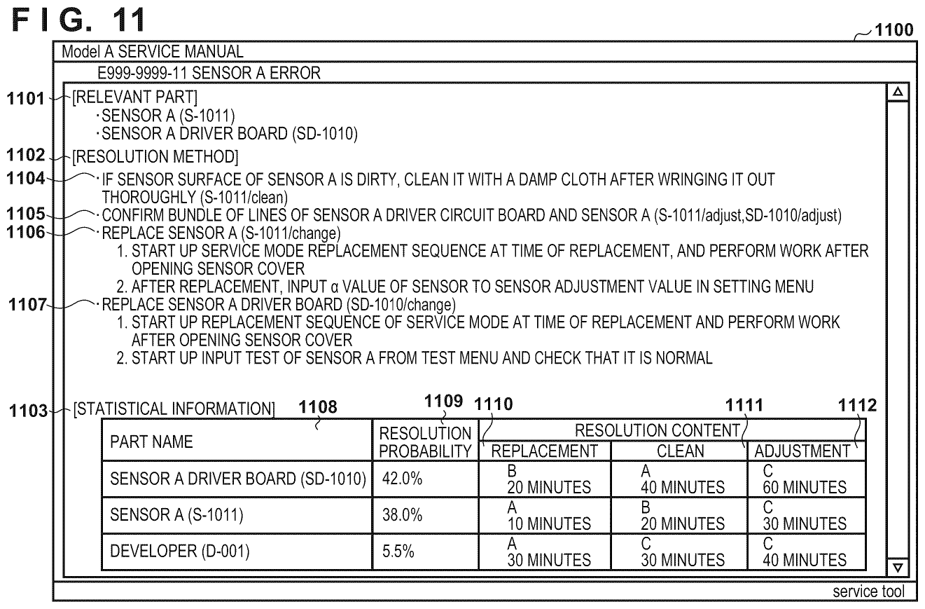

The work list 1002 for errors is constituted by a code column 1004, a type column 1005, and a name column 1006. The code column 1004 displays a unique code assigned to each error, and the name column 1006 displays the name of the error. In the type column 1005, type information indicating the level of the error is displayed, and by referring to this type information, the seriousness of the error and the required level of the maintenance worker can be understood. The work list 1002 is displayed in order according to the error type information, with more serious errors being displayed at the top. A link for opening a service manual corresponding to the selected error is embedded in the character strings of link information 1007 and 1008, and when a maintenance worker selects this, the service manual screen shown in FIG. 11, which will be described later, opens for reference.

The work list 1003 for maintenance items is constituted by a code column 1009, a name column 1010, and an estimated remaining days column 1011. The code column 1009 displays a unique code assigned to each maintenance item, and the name column 1010 displays the name of the maintenance item. The estimated remaining days column 1011 displays the number of days remaining until the deadline for maintenance work. The work list 1003 is displayed in order according to the estimated remaining days, with maintenance items that are due sooner being displayed at the top. A link for opening a service manual corresponding to the selected maintenance item is embedded in the character string of link information 1012 and 1013, and when a maintenance worker selects this, the service manual screen shown in FIG. 11, which will be described later, opens for reference.

FIG. 11 shows an example of a service manual that is displayed when the service manual stored in the service manual storage unit 307 of the maintenance service terminal 107 is opened from the link information 1007 in the work list 1002.

The service manual 1100 is constituted by relevant parts 1101, a resolution method 1102, and statistical information 1103. The relevant parts 1101 and the resolution method 1102 are generated by the service manual content generation unit 407, and the statistical information 1103 is generated by the market record information generation unit 406. The service manual 1100 displays the model name (Model A in FIG. 11) as its title, and the code and name of the error or maintenance item (Sensor A Error in FIG. 11). The content is a service manual for errors or maintenance items for the model displayed in the title. The relevant parts 1101 lists the parts relevant to the error or maintenance item. That is, they can be considered to be parts that may be causing an error. The resolution method 1102 describes the procedure for addressing the error or maintenance item, and if there are a plurality of causes of errors or a plurality of maintenance works, a plurality of resolution methods are described, such as resolution methods (contents of resolution methods) 1104, 1105, 1106, and 1107. In this embodiment, the procedure is described using only text, but the procedure may also be illustrated by providing images or videos in the resolution method.

The statistical information 1103 is constituted by a part name column 1108, a resolution probability 1109, a replacement column 1110 of resolution content, a cleaning column 1111 of resolution content, and an adjustment column 1112 of resolution content. In the cells of the replacement column 1110, the cleaning column 1111, and the adjustment column 1112, work time information is displayed as described in step S905. As a result of the flowchart of FIG. 9, statistical information reflected in the service manual DB 410 is displayed.

In the example of FIG. 11, statistical information reflected in the service manual DB 410 for “sensor A error” of “Model A” is displayed. In the part name column 1108, information corresponding to the addressed part column 703 of the statistical information 700 is displayed. Similarly, a resolution probability column 1109 displays information corresponding to the resolution probability column 704. In the replacement column 1110 of resolution content, information corresponding to the replacement column 705 of resolution content and the replacement column 708 of work time is displayed. Similarly, the cleaning column 1111 of resolution content displays information corresponding to the cleaning column 706 of resolution content and the replacement column 709 of work time, and the adjustment column 1112 of resolution content displays information corresponding to the adjustment column 707 of resolution content and the replacement column 710 of work time. As described above, in step S905, the parts are rearranged in descending order of the resolution probability 704 and the statistical information 700 is embedded in the service manual, and therefore the order of part names displayed in the statistical information 1103 is in descending order of values of the resolution probability 1109.

The maintenance worker refers to this statistical information 1103, and views the replacement column 1110, the cleaning column 1111, and the adjustment column 1112 for the part that is displayed first and has the highest value in the resolution probability column 1109, to check the resolution content that has the highest resolution record. At the same time, the maintenance worker also reads, from the statistical information 1103, the work time required to implement the resolution method. The maintenance worker compares the scheduled work time for which work can be performed on that day with the work time of the resolution method with the highest rank in the resolution record read from the statistical information 1103. If the work time of a resolution method with a high rank of resolution record is shorter than the scheduled work time for which work can be performed on that day, the resolution method with the high rank of resolution record is carried out. If the work time of a resolution method with a high rank of resolution record is not within the scheduled work time for which work can be performed on that day, it is possible to know that the work will not be completed that day even if that resolution method is performed. In that case, another resolution method is considered.

For example, the scheduled work time for which a maintenance worker can work on that day is 30 minutes. In this case, when an attempt is made to perform resolution in which the part name is “sensor A” and the resolution probability is 42.0%, the resolution content is performing “cleaning” work with an “A” rank. However, statistical information 1103 indicates that “cleaning” takes 40 minutes. In this case, the work will not be completed within the scheduled work time of 30 minutes, and therefore performing this work would mean, for example, that the maintenance worker is sent home partway through the work. For this reason, a resolution of the “Sensor A Driver Board”, which has the next-highest resolution probability of 38.0%, will be considered. When treating the “Sensor A driver board”, the resolution content is to perform “replacement” work of an “A” rank. It is understood from the statistical information 1103 that “replacement” takes 10 minutes. This work can be completed within 30 minutes, which is the scheduled work time, and therefore it is sufficient to perform this work. Then, the specific procedure for the resolution content is searched for in the resolution method 1102, and the repair work or maintenance work for the error is performed according to the procedure.

### Display Processing

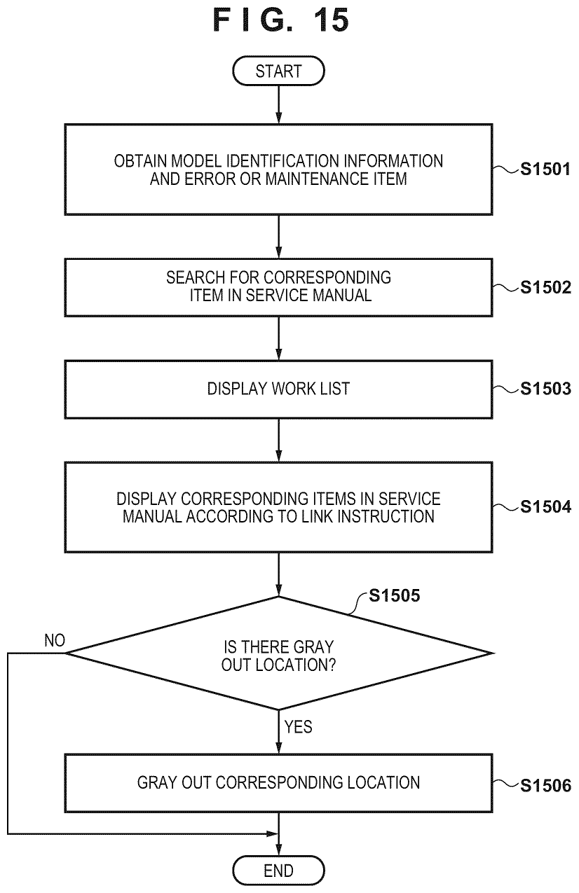

FIG. 15 shows a display control procedure performed by the service tool 303 for displaying the work list in FIG. 10 and the service manual in FIG. 11. This processing is executed mainly by the work list display unit 306 in terms of software, and mainly by the CPU 201 in terms of hardware.

First, the work list display unit 306 acquires device information including model identification information and serial number of the apparatus to be worked on, and error and/or maintenance item codes, via the device information acquisition unit 304 (step S1501). The work list display unit 306 searches the service manual stored in the service manual storage unit 307 using the acquired device information to obtain information on the corresponding item (step S1502). The work list display unit 306 displays the work list 1000 illustrated in FIG. 10 based on the acquired information (step S1503). At this time, for each error or maintenance item, a link to the corresponding service manual acquired in step S1502 is included in the work list.

When a link to a service manual is instructed from the work list 1000, the work list display unit 306 accordingly displays the linked service manual (step S1504). Then, the work list display unit 306 determines whether the displayed service manual includes information instructing gray-out of the manual (step S1505). If there is information instructing gray-out, the work list display unit 306 changes the location instructed to be grayed out, for example, the background of the target content, to gray and displays the result (step S1506).

Note that in the first embodiment, since information instructing gray-out is not written in the service manual, steps S1505 and S1506 may be omitted.

In this way, the service manual updated according to the procedure of FIG. 9 can be displayed by the maintenance service terminal 107. Note that instead of displaying the information in gray against a gray background, the information may be displayed in another color. In addition, the display is not limited to color, and any display mode may be used as long as it is distinguishable from other portions. Alternatively, instead of displaying the portion in gray, the portion may be hidden.

According to this embodiment, using the configuration and procedures described above, a service manual can be downloaded to a service/maintenance service terminal used by a worker at the work site, allowing the worker to use the service manual even while offline. The service manual can also display, for each model, each error or maintenance work, and each addressed part, the rate at which the addressed part was selected (resolution probability) and the resolution method (resolution content) that can be taken for that part. This allows the worker to determine the addressed part based on past work record. Furthermore, the resolution methods can be ranked based on the rate of the selected resolution method and displayed together with the rank. This allows the worker to determine the resolution method based on past work record. Furthermore, the time required for each resolution method can be displayed based on past work record. This allows the worker to select an addressed part that can be addressed within the allowed work time, and a resolution method.

This allows an operator to select the most appropriate method of resolving an error or maintenance work from among the resolution methods that can be executed within a limited time, thereby improving work efficiency. This makes it possible to shorten the downtime of the target image forming apparatus, and to reduce losses caused by the downtime.

### Second Embodiment

In the first embodiment, the work time information input in the “registration of work time” screen of the work time information input unit 411 in FIG. 5 was a record value for each resolution method for an error or maintenance item. However, the work time information does not need to be a record value, and may be an estimated work time. In view of this, in the second embodiment, an embodiment will be described in which the work time information input in the “registration of work time” screen of the work time information input unit 411 is an estimated work time.

First, in the “registration of work time” of FIG. 5, the estimated time for each resolution method for an error or maintenance item is registered in the service work record DB 401 in advance. For example, a development department and a maintenance department work together to create information on the estimated time required for each resolution method, and register the created information in “registration of work time” on the screen of the work time information input unit 411 (FIG. 5). Since these are not record values, the information on the estimated time for each resolution method is a fixed value.

Accordingly, in the work time column 606 in FIG. 6, the estimated work time (fixed value) is registered instead of the work time of the record value.

As a result, the estimated work times (fixed values) are stored in the replacement column 708, cleaning column 709, and adjustment column 710 of the work time in FIG. 7.

In calculating the work time information in step S805 of FIG. 8, no record values are used, and therefore the estimated work times (fixed values) are stored in the replacement column 708, cleaning column 709, and adjustment column 710 of the work time for each resolution content of each addressed part, namely “replacement”, “cleaning”, or “adjustment”.

The above are the differences from the first embodiment, and other system configurations, apparatus configurations, data contents, and processing procedures are the same as those of the first embodiment.

### Third Embodiment

In the first embodiment, the scheduled work time was registered on the screen of the work time information input unit 411 (FIG. 5), but the display of the statistical information 1103 on the service manual screen in FIG. 11 only displayed the work time information.

In view of this, in the third embodiment, an embodiment will be described in which the display content of the statistical information 1103 on the service manual screen in FIG. 11 is changed depending on the scheduled work time input in “registration of scheduled work time” on the screen of the work time information input unit 411. The difference from the first embodiment is step S904 in FIG. 9. The rest is the same as in the first embodiment.

In the first embodiment, in step S904, the market record information generation unit 406 acquires intermediate data of the service manual for the target model and the error or maintenance item acquired in steps S901 and S902 from the service manual content intermediate DB 408. Then, the statistical information obtained in step S903 is embedded in this intermediate data. At this time, the work time information is displayed in the respective cells for “replacement”, “cleaning”, and “adjustment” in the resolution content. The same applied to the present embodiment as well. Then, in the first embodiment, when embedding the statistical information in step S904, the parts are rearranged in descending order of the resolution probability 704 such that the maintenance worker can easily check the order of the record. This embodiment is different in this respect.

In this embodiment, in step S904, the scheduled work time acquired from the service work record DB 401 in step S903 is used, and for resolution content that cannot be completed within the scheduled work time, the cell is displayed in gray such that the maintenance worker cannot select the resolution methods and perform the work. Since the graying out is performed by the service tool 303, the market record information generation unit 406 may, for example, write an instruction or code in the relevant location such that the service tool 303 will gray out the relevant location. In addition, the maintenance worker selects and works on the resolution method that is ranked A, but the parts are rearranged in ascending order of the work time for the resolution method with the rank A, which is the highest rank. Note that resolution content that cannot be completed within the scheduled work time is resolution content whose work time is longer than the scheduled work time.

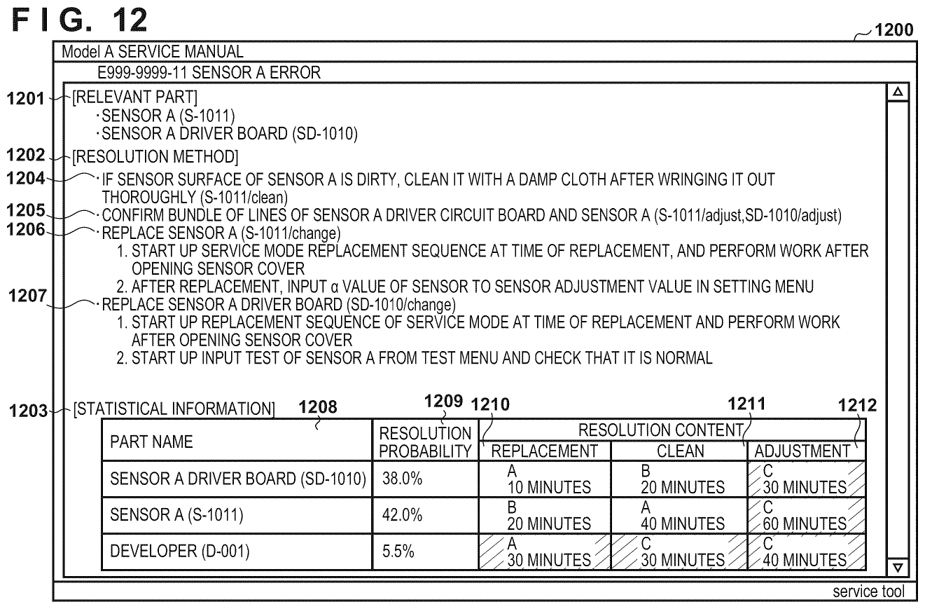

FIG. 12 shows an example of displaying statistical information in grayed-out cells. The relevant parts 1201 to the resolution method 1212 in FIG. 12 correspond to the relevant parts 1101 to the resolution method 1112 in FIG. 11, respectively. Cells that are grayed out in the replacement column 1210, the cleaning column 1211, and the adjustment column 1212 in FIG. 12 are resolution contents whose work times are longer than the scheduled work times acquired from the service work record DB 401, that is, they are resolution contents for which it is difficult to complete work within the scheduled work time. By graying out a cell, the maintenance worker can be prevented from selecting the resolution.

Additionally, the cleaning column 1211 for “sensor A” is ranked A and its work time is 40 minutes. On the other hand, the replacement column 1210 for “sensor A driver board” is ranked A, and the work time is 10 minutes. In this embodiment, the parts are rearranged and displayed in ascending order of rank A work time. For this reason, in FIG. 12, the “sensor A driver board”, which has a resolution probability of 38.0%, is displayed above “sensor A”, which has a resolution probability of 42.0%. The maintenance worker refers to the statistical information 1203, selects the part that is displayed at the top of the list and has resolution content ranked as A, and performs work. In particular, when there are parts with similar values of the resolution probability 1209, this enables the maintenance worker to select work that can be completed within the scheduled work time, instead of work that cannot be completed within the scheduled work time. This prevents the worker from stopping work partway through and continuing it the next day, thereby shortening equipment downtime.

### Fourth Embodiment

In this embodiment, an embodiment in which the content displayed in the service manual can be switched based on information related to the work time input in the work time information input unit 411 will be described. The difference from the first embodiment is the work time information input unit 411 and the processing content in step S904. The rest is the same as in the first embodiment.

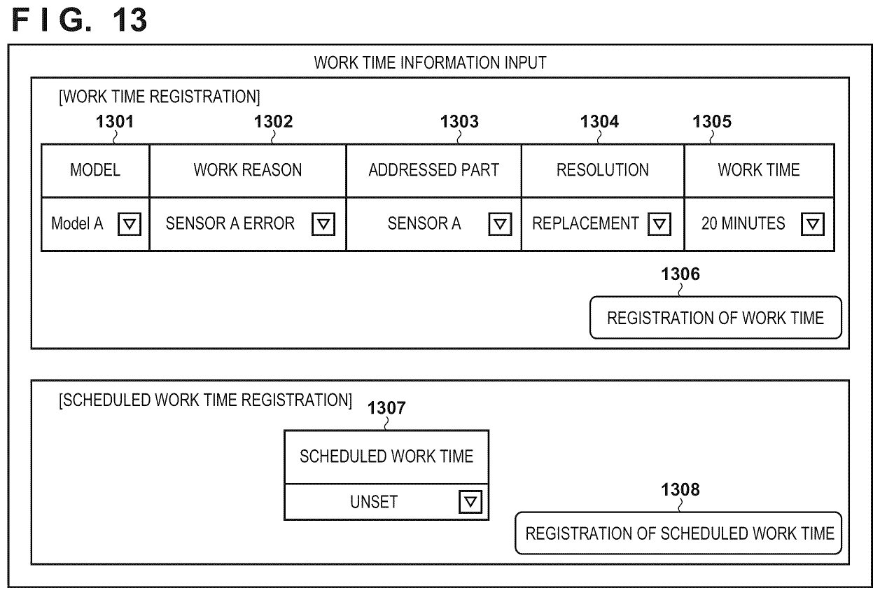

FIG. 13 is an example of a screen of the work time information input unit 411 of this embodiment. A model name 1301 to registration of scheduled work time 1308 in FIG. 13 corresponds to the model name 501 to the registration of scheduled work time 508 in FIG. 5. In the scheduled work time 1307, similarly to the scheduled work time 507 in the first embodiment, the scheduled work time can be selected from a pull-down menu in 5-minute increments.

In addition, in this embodiment, an item “not set” is provided in the pull-down menu, so that “not set” can be selected from the pull-down menu. In this state, when the “registration of scheduled work time” button 1308 is pressed, the scheduled work time is registered in the service work record DB 401 in a manner that makes it clear that “not set” has been selected. In the case of performing management using numbers, for example, “9999” may be registered in the service work record DB 401.

In the first embodiment, in step S904, the market record information generation unit 406 acquired intermediate data of the service manual for the target model and the error or maintenance item acquired in steps S901 and S902 from the service manual content intermediate DB 408. The same applies to the present embodiment as well. In the first embodiment, in step S904, the statistical information 700 acquired in step S903 was further embedded in this intermediate data. At this time, the work time information is recorded so as to be displayed in the respective cells of “replacement”, “cleaning”, and “adjustment” in the resolution content. In addition, when embedding the statistical information, the parts are rearranged in descending order of the resolution probability 704 such that the maintenance worker can easily check the record order. In contrast, in this embodiment, if the scheduled work time has been input in the processing for embedding statistical information, the way in which the service manual is displayed and the order in which it is sorted are changed depending on that value, which is different from the first embodiment.

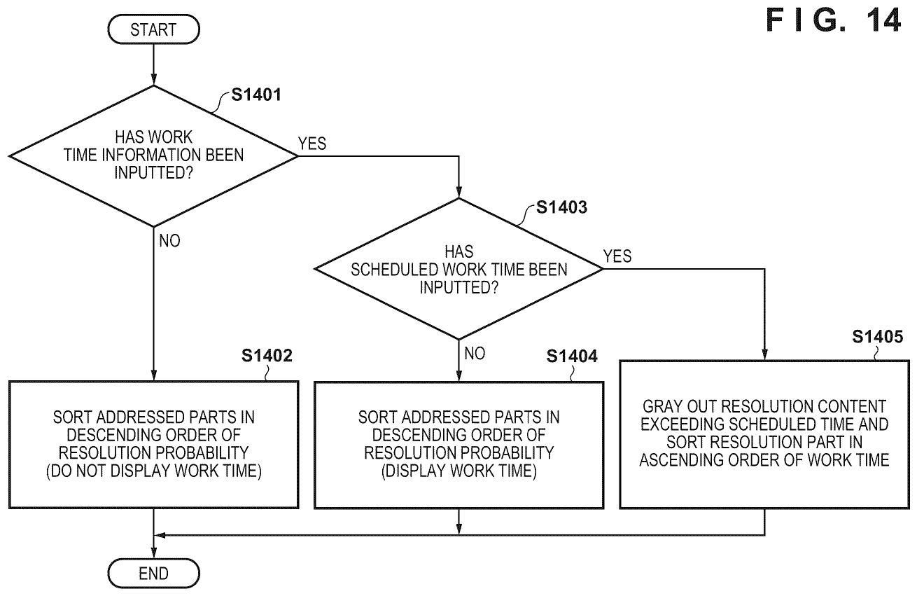

FIG. 14 is a flowchart relating to the change of display content in this embodiment. FIG. 14 shows details of processing for embedding the statistical information 700 in this intermediate data in step S904 in the procedure of FIG. 9. In step S1401, the market record information generation unit 406 checks whether work time information has been input in the work time columns 708, 709, and 710 of the statistical information 700 acquired in step S903. If the work time information has not been input, the processing proceeds to step S1402, and if the work time information has been input, the processing proceeds to step S1403. If any one of the items has been input, it may be determined that the information has been input. In step S1402, the parts are rearranged in descending order of the resolution probability 704. In this case, since no work time has been input, the service tool 303 displays the service manual without displaying the work time. If the work time has been input, the market record information generation unit 406 acquires the “scheduled work time” from the service work record DB 401 in step S1403. Then, it is checked whether or not time information has been input into the acquired “scheduled work time”. If the information has not been input, that is, if the information is set to “not set”, the processing proceeds to step S1404. For example, if the value of the scheduled work time acquired from the service work record DB 401 is “9999”, it can be determined as “not set”. If the information has been input, the processing proceeds to step S1405. In step S1404, the parts are rearranged in descending order of the resolution probability 704. In this case, since the work time has been input, the service tool 303 displays the service manual with the work time displayed. In step S1405, two processes are performed. First, for resolution content that cannot be completed within the scheduled work time, information for causing the service tool 303 to gray out the relevant resolution content is stored in the service manual such that the maintenance worker does not select that resolution method and perform the work. Furthermore, the parts are rearranged in ascending order of the work time for rank A. If the resolution content includes information indicating graying out, the service tool 303 grays out the column of the resolution content and displays the service manual. In this way, it becomes possible to switch the content displayed in the service manual based on the information relating to the work time input in the work time information input unit 411.

According to this embodiment, due to resolution content that will not be completed within the predetermined scheduled time being grayed out, the worker can easily identify the relevant work content and can be prevented from selecting such work. In this case, by highlighting the addressed part in ascending order of the working time, it becomes easier to select work content that is more in line with the work time restrictions. This can prevent the downtime of the target image forming apparatus from being extended.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-093860, filed Jun. 10, 2024 which is hereby incorporated by reference herein in its entirety.

What is claimed is:

1. A service manual display method to be executed by a computer, comprising:
displaying a list of errors and/or maintenance items for an apparatus that is to be addressed; and
displaying a service manual corresponding to an item selected from the listed errors and/or maintenance items,
wherein in the displaying of the service manual, work time for each selectable resolution content is displayed for a selected error or maintenance item.

2. The service manual display method according to claim 1,
wherein in the displaying of the service manual, the resolution content for which the work time is longer than a set scheduled work time is displayed in a mode that allows the resolution content to be identified from other resolution content.

3. The service manual display method according to claim 1,
wherein in the displaying of the service manual, the resolution content for which the work time is longer than a set scheduled work time is not displayed.

4. The service manual display method according to claim 2,
wherein the selectable resolution content is displayed for each part that can be selected for each of the selected errors or maintenance items, and the selectable resolution content is classified by rank according to a record selected for each resolution content, and
in the displaying of the service manual, the selectable parts are displayed in an order according to the work time of the resolution content classified in the highest rank for each of the parts.

5. The service manual display method according to claim 4,
wherein if the scheduled work time has not been set, in the displaying of the service manual, the selectable parts are displayed in an order based on the record selected for each of the parts.

6. The service manual display method according to claim 1,
wherein if the work time for each resolution content is not included in the service manual, the work time for each resolution content is not displayed in the displaying of the service manual.

7. The service manual display method according to claim 1,
wherein the work time for each resolution content is based on a record value.

8. The service manual display method according to claim 1,
wherein the work time for each resolution content is a pre-set work time.

9. The service manual display method according to claim 1,
wherein the resolution content includes replacement of a part, cleaning of a part, and adjustment of a part.

10. The service manual display method according to claim 1, further comprising
displaying an updated service manual,
wherein the updated service manual is updated through the following steps, which include:
creating statistical information associating respective work times with resolution methods that can be selected for errors or maintenance items of a target apparatus based on information indicating a record of maintenance work; and
updating the service manual by associating the statistical information with a resolution method for the error or maintenance item in the service manual.

11. An information processing apparatus, comprising:
at least one memory storing instructions; and
at least one processor that is in communication with the at least one memory and that, when executing the instructions, cooperates with the at least one memory to execute processing, the processing including:
displaying a list of errors and/or maintenance items for an apparatus that is a target of resolution; and
displaying a service manual corresponding to an item selected from the listed errors and/or maintenance items,
wherein in the displaying of the service manual, a work time for each selectable resolution content is displayed for the selected error or maintenance item.

12. A maintenance support system comprising a first information processing apparatus and a second information processing apparatus,
wherein the first information processing apparatus includes:
at least one memory storing instructions; and
at least one processor that is in communication with the at least one memory and that, when executing the instructions, cooperates with the at least one memory to execute processing, the processing including:
displaying a list of errors and/or maintenance items for an apparatus that is a target of resolution; and
displaying a service manual corresponding to an item selected from the listed errors and/or maintenance items,
in the displaying of the service manual, work time for each selectable resolution content for the selected error or maintenance item is displayed,
the second information processing apparatus includes:
at least one memory storing instructions; and
at least one processor that is in communication with the at least one memory and that, when executing the instructions, cooperates with the at least one memory to execute processing, the processing including:
creating statistical information associating respective work times with resolution methods that can be selected for the errors or maintenance items of the target apparatus based on information indicating a record of maintenance work; and
updating the service manual by associating the statistical information with a resolution method for the error or maintenance item in the service manual,
the processing of the first information processing apparatus further includes downloading an updated service manual by the second information processing apparatus, and
in the displaying of the service manual, the downloaded service manual is displayed.
